(19) United States
(12) Patent Application Publication
(10) Pub. No.: US 2017/0198493 A1
(43) Pub. Date: Jul. 13, 2017

(54) Concealed Screw Handleset

(71) Applicant: Copper Creek Inc., Murrieta, CA (US)

(72) Inventors: Ronald DeGoutiere, Murrieta, CA (US); Tae H. Lee, Murrieta, CA (US)

(21) Appl. No.: 15/406,272

(22) Filed: Jan. 13, 2017

Related U.S. Application Data
(60) Provisional application No. 62/278,408, filed on Jan. 13, 2016.

(51) Int. Cl. E05B 9/08; E05B 9/00

(52) U.S. Cl. CPC E05B 9/082; E05B 9/002

(57) ABSTRACT

An improved concealed screw handleset for a door is described. The handleset assembly has a handleset, a mounting plate, and a face plate. The handleset and mounting plate are fastened together on opposite sides of the door via one or more assembly screws. The assembly screws are inserted from the mounting plate side of the door and are not visible from the handleset side of the door. The faceplate mounts on the mounting plate via two threaded collars. The faceplate completely covers the mounting plate and the assembly screws. In this manner, the handleset assembly provides a concealed screw design that is very easy to assemble and install. In other aspects, the mounting plate has a rotatable stem for mounting a turn-piece. The stem has one or more catches to hold the turn-piece in different positions.

This application claims the benefit of priority to U.S. Provisional Application No. 62/278,408, filed Jan. 13, 2016.

### FILED OF THE INVENTION

The field of the invention is handlesets for doors.

### BACKGROUND

The background description includes information that may be useful in understanding the present invention. It is not an admission that any of the information provided herein is prior art or relevant to the presently claimed invention, or that any publication specifically or implicitly referenced is prior art.

Various handleset assemblies for doors and are known. Such handlesets are used to open and close doors, lock doors, and provide an ornamental aspect. Handleset assemblies typically include one or more handles (e.g., knob, lever) that actuate a latch-bolt assembly, and a turn-piece and deadbolt cylinder that actuate a deadbolt assembly. Examples of handlesets, locksets, and latchsets are disclosed in: USD0501389, USD0501634, USD0571183, USD0579302, USD0579760, USD0642044, USD0697385, USD0739203, USD0743237, US2831336, US4453753, US4502720, US4526256, US4674776, US5259652, US5351513, US5611227, US5765412, US5810402, US6401932, US6802546, US7934754, US8176761, US8424935, US6401932, US8939477, US20030041633, US20060138788, US20080054651, US20080079267, US20100257906, US20110314878, US20120055213, US20130139563, US20140047878, US20140159392, US20150345175, US20150015003, GB2154439, GB2189860, GB2296033, GB2314583, GB2315806, GB9125230, GB9711989, JP08026694, WO2005116377, and WO2015168679. Examples of commercially available handlesets include: Omnia Industries Entrance Handlesets (www.omniaindustries.com/image/data/catalogs/omnia_entrance_handleset_catalog_2014.pdf), Baldwin Hardware Estate Prestige Handlesets (www.baldwinhardware.com/products/category/door-hardware/estate/entrance), Schlage Entry Handlesets (www.schlage.com/en/home/products/products-handlesets.html), Fusion Entry Hardware and Deadbolts (www.fusionhardware.com/en/products/handlesets.html), and Emtek Assa Abloy Tubular Entrance Handlesets and Locksets (www.emtek.com/tubular-entrysets).

All extrinsic materials cited herein, including patent publications and commercial references, are incorporated by reference to the same extent as if each individual reference was specifically and individually indicated to be incorporated by reference. Where a definition or use of a term in an incorporated reference is inconsistent or contrary to the definition of that term provided herein, the definition of that term provided herein applies and the definition of that term in the reference does not apply.

Some of the preferred characteristics of a handleset assembly include: (i) an attractive and stylish design, (ii) easy to assemble and install, (iii) minimal-to-no wobble in the handle(s), (iv) no lever sagging, (v) minimal number of components, and (vi) inexpensive. In many instances, a concealed screw handleset is preferred to provide an attractive appearance. While others have attempted to provide a concealed screw handleset, such prior efforts have produced complicated assemblies that often suffer from wobble and/or lever sag.

Thus, there is still a need for improved concealed screw handlesets.

### SUMMARY OF THE INVENTION

The present invention provides apparatus, systems, and methods in which a handleset assembly provides a concealed screw appearance and design. As used herein, the term “concealed screw” means there are no visible assembly screws when the handleset is installed on a door, although tiny set screws may still be visible but not readily noticeable. Contemplated handleset assemblies include a handleset (either a one piece design or a two piece design), a mounting plate, and a faceplate. The handleset and mounting plate are fastened together on opposite sides of the door via one or more assembly screws. The assembly screws are inserted from the mounting plate side of the door and are not visible on the handleset side. Once the handleset and mounting plate are fastened together, the faceplate is then fastened to the mounting plate using two threaded collars. The faceplate completely covers the mounting plate and the assembly screws. In this manner, the handleset assembly provides a concealed screw design that is very easy to assemble and install.

In one aspect of the inventive subject matter, the mounting plate has two holes with internal threads that mate with the two threaded collars. A rotatable stem extends from the first threaded hole and is sized and dimensioned for attaching a turn-piece. A rotatable spindle through-hole is disposed in the center of the second threaded hole and is sized and dimensioned to receive, and mechanically engage with, a spindle via one or more set screws. The rotatable spindle through-hole is coupled with a torsion spring to provide a resistance to rotation. One end of the spindle is sized and dimensioned to engage a handle. The rigid coupling of the spindle with the through-hole (via the set screws) and the torsion spring help to reduce and or eliminate handle wobble (also referred to as play or wiggle). The mounting plate also has one or more assembly screw holes that are sized and dimensioned to receive one or more assembly screws, which are used to fasten the mounting plate to the handleset.

In another aspect of the inventive subject matter, the handleset has an opening that is sized and dimensioned to receive a deadbolt cylinder assembly. The deadbolt cylinder assembly has a key hole on an outward facing surface (i.e., away from the door) and a tail piece extending from an inward facing surface (i.e., towards the door). The deadbolt cylinder assembly houses a locking mechanism that turns the tail piece when a key is inserted into the key-hole and rotated. The tail piece is sized and dimensioned to mechanically engage a slot or opening in the rotatable stem of the mounting plate. The inward facing surface of the deadbolt cylinder assembly also has one or more threaded assembly screw holes for attaching the mounting plate.

The handleset also includes a handle and a thumb piece on an outward facing surface, and a chassis member on an inward facing surface. The chassis member is functionally coupled with the thumb piece and has a spindle opening that is sized and dimensioned to receive the spindle. The spindle opening also has one or more set screws for rigidly coupling the chassis member to the spindle, and is coupled with a torsion spring that provides rotational resistance. The thumb piece and chassis member are configured to rotate the spindle when the thumb piece is pressed. The chassis member has one or more threaded assembly screw holes for attaching the mounting plate.

In yet another aspect of the inventive subject matter, the faceplate has a first opening and a second opening separated by the same distance of separation as the mounting plate's two threaded holes. When the faceplate is fastened to the mounting plate the threaded holes on the mounting plate align with the openings on the face plate, such that the rotatable stem extends through the first opening and the spindle extends through the second opening. Once the two collars are used to fasten the faceplate to the mounting plate, a turn-piece is attached to an end of the stem and a handle is attached to an end of the spindle. The turn-piece and handle are sized and dimensioned to completely cover the first and second collars, respectively.

The inventive subject matter also provides apparatus, systems, and methods in which a mounting plate for a concealed screw handleset assembly includes a rotatable stem with catches (e.g., grooves, channels, indentations, cavities, openings, etc.) that mate with a spring-loaded ball-catch. As the stem is rotated the ball-catch is pressed into the catch to temporarily lock the stem in place. The stem can then be rotated further until the ball-catch engages the next catch. The catches on the stem can be separated by predetermined radial distances (e.g., every 90 degrees, every 180 degrees, etc.) depending upon the configuration of the deadbolt assembly. In this manner, a turn-piece attached to the rotatable stem can be held securely in an unlocked orientation/position and a locked orientation/position, thereby preventing turn-piece wobble (or play or wiggle). In other aspects, a pin can be used to engage a catch on the rotatable stem, preventing the stem from rotating. In this manner, a turn-piece on a double door can be converted into a dummy (i.e., non-functional) turn-piece.

One should appreciate that the disclosed subject matter provides many advantageous technical effects including providing a concealed screw handleset assembly. The disclosed subject matter also provides a handleset assembly that is easy to assemble and install, has a convertible dummy turn-piece, and reduces turn-piece wobble and handle wobble.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is an exploded view of a handleset assembly and a door.

FIG. 2 is a perspective view of the door of FIG. 1.

FIG. 3 is a rear perspective view of the handleset in FIG. 1.

FIG. 4a is a rear perspective view of the deadbolt cylinder in FIG. 1

FIG. 4b is a front perspective view of the deadbolt cylinder in FIG. 1.

FIG. 5a is an exploded rear perspective view of the mounting plate in FIG. 1

FIG. 5b is a front perspective view of the mounting plate in FIG. 1.

FIG. 5c is a rear perspective view of the mounting plate in FIG. 1.

FIG. 5d is a rear plan view of the mounting plate in FIG. 1.

FIG. 5e is a front plan view of the mounting plate in FIG. 1.

FIG. 5f is a side view of the mounting plate in FIG. 1.

FIG. 5g is a close-up top, rear, perspective view of the mounting plate of FIG. 1.

FIG. 6a is a rear perspective view of the stem in FIG. 5a.

FIG. 6b is a front perspective view of the stem in FIG. 5a.

FIG. 6c is a side view of the stem in FIG. 5a.

FIG. 6d is a rear plan view of the stem in FIG. 5a.

FIG. 6e is a front plan view of the stem in FIG. 5a.

FIG. 7a is a front perspective view of the spindle through-hole in FIG. 5a.

FIG. 7b is a rear perspective view of the spindle through-hole in FIG. 5a.

FIG. 7c is a side view of the spindle through-hole in FIG. 5a.

FIG. 7d is a front plan view of the spindle through-hole in FIG. 5a.

FIG. 7e is a rear plan view of the spindle through-hole in FIG. 5a.

FIG. 8a is an exploded front perspective view of the mounting plate and faceplate in FIG. 1.

FIG. 8b is an exploded rear perspective view of the mounting plate and faceplate in FIG. 1.

FIG. 8c is a rear perspective view of the mounting plate and faceplate in FIG. 1.

FIG. 8d is a side view of the mounting plate and faceplate in FIG. 1.

FIG. 9 is an exploded view of the spindle in FIG. 1

FIG. 10 shows a rear plan view of the turn-piece in FIG. 1.

### DETAILED DESCRIPTION

The following discussion provides example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

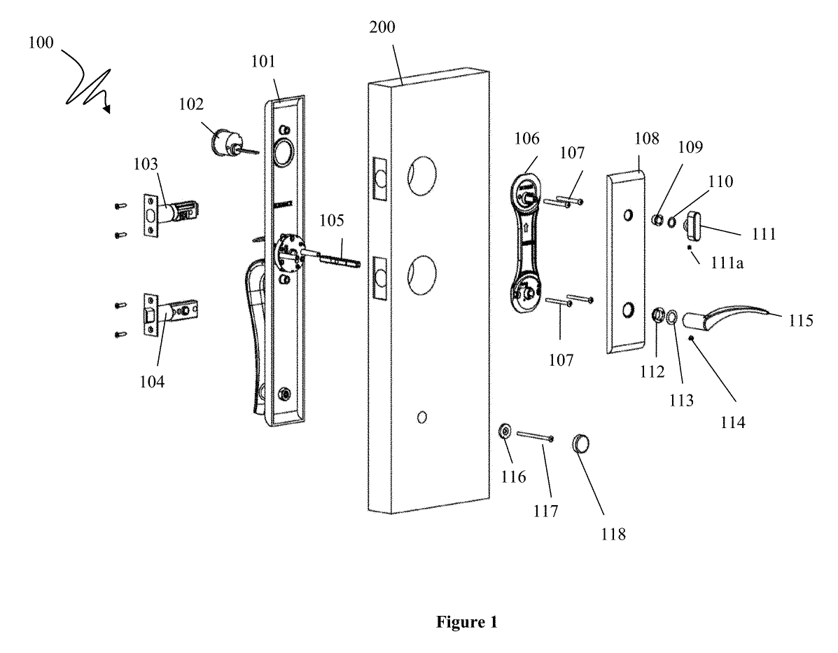

FIG. 1 shows an exploded view of a handleset assembly 100 and a door 200. Handleset assembly 100 comprises a handleset 101, a deadbolt cylinder 102, a deadbolt assembly 103, a latch-bolt assembly 104, a spindle 105, a mounting plate 106, assembly screws 107, a face plate 108, a first collar 109, a first washer 110, a turn-piece 111, a second collar 112, a second washer 113, a handle 115 (with a set screw 114), a washer 116, a handleset screw 117, and a cover 118. Handleset assembly 100 has a concealed crew design, in which assembly screws 107 are hidden once assembly 100 is installed on door 200. Each of the components of assembly 100 will now be described in more detail.

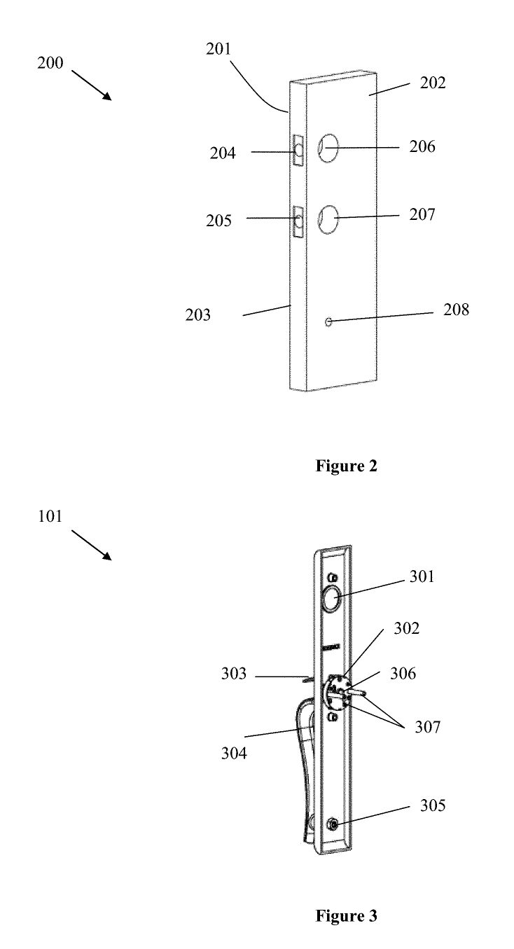

FIG. 2 shows a perspective view of door 200. Door 200 has a first major surface 201, a second major surface 202, and a first minor surface 203 (e.g., an edge surface). Surface 203 has a first blind-hole 204 (e.g., a first edge bore) and a second blind-hole 205 (e.g., a first edge bore). Blind-hole 204 is sized and dimensioned to receive deadbolt assembly 103 and blind-hole 205 is sized and dimensioned to receive latch-bolt assembly 104.

Door 200 also has a first cross through-hole 206 (e.g., a cross bore) that perpendicularly intersects with blind-hole 204 and a second cross through-hole 207 (e.g., a cross bore) that perpendicularly intersects with blind-hole 207. First cross through-hole 206 is sized and dimensioned to receive deadbolt cylinder 102. Second cross through-hole 207 is sized and dimensioned to receive a chassis member 302 on handleset 101. In addition, door 200 has a third through-hole 208 sized and dimensioned to receive handleset assembly screw 117.

FIG. 3 shows a rear perspective view of handleset 101. Handleset 101 has an opening 301 sized and dimensioned to receive deadbolt cylinder 102. Handleset 101 also has a chassis member 302. Chassis member 302 has a spindle hole 306 that is sized and dimensioned to receive, and mechanically engage, spindle 105. Chassis member 302 also has two threaded screw holes 307, which are sized and dimensioned to mate with assembly screws 107. Handleset 101 additionally comprises a thumb-piece 303 that actuates chassis member 302 and spindle 105. More specifically, pressing thumb-piece 101 down causes spindle 105 to rotate. Finally, handleset 101 has a handle 304 for opening door 200, and a threaded opening 305 for fastening handle 304 to door 200.

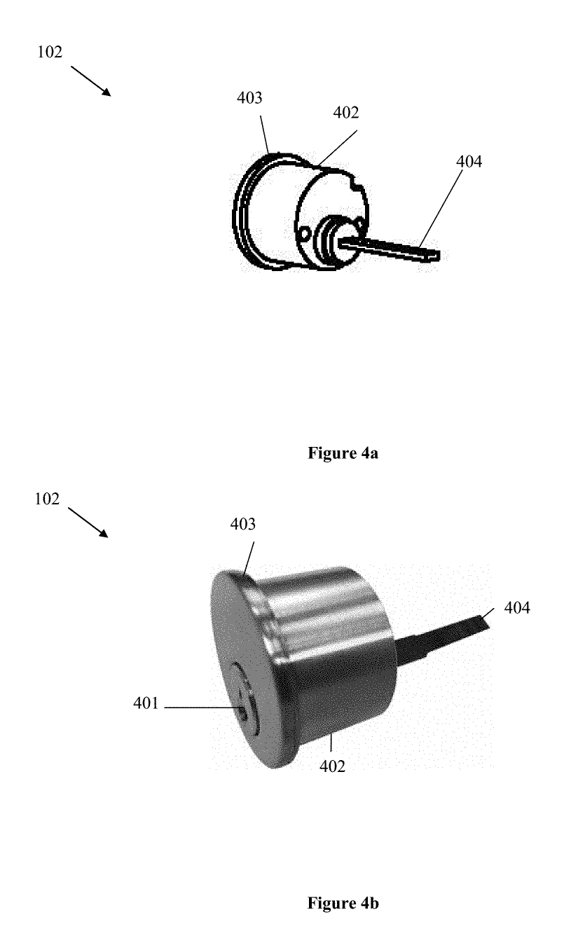

FIG. 4a shows a rear perspective view of deadbolt cylinder 102. FIG. 4b shows a front perspective view of deadbolt cylinder 102. Deadbolt cylinder 102 has a key hole 401 that is sized and dimensioned to receive a key. Deadbolt cylinder 102 also has a cylindrical housing 402 that houses a locking mechanism configured to rotate tail piece 404 when a key is inserted into key hole 401 and rotated. Tail piece 404 extends from the rear of cylindrical housing 402 and has a cross section that mechanically engages opening 603 in stem 600. Cylindrical housing 402 has an annular flange 403 that is sized and dimensioned to stop deadbolt cylinder 102 from being inserted completely through opening 301. Cylindrical housing 402 has a cylindrical shape, however non-cylindrical shapes are also contemplated.

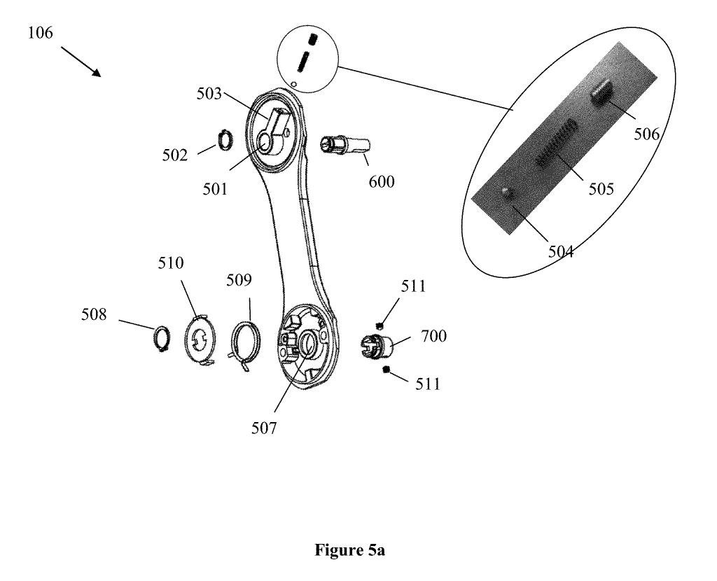

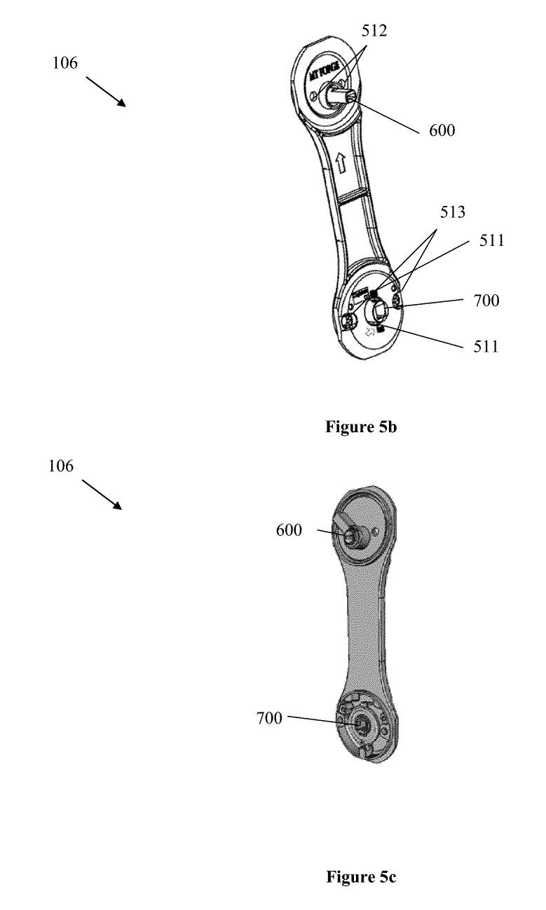

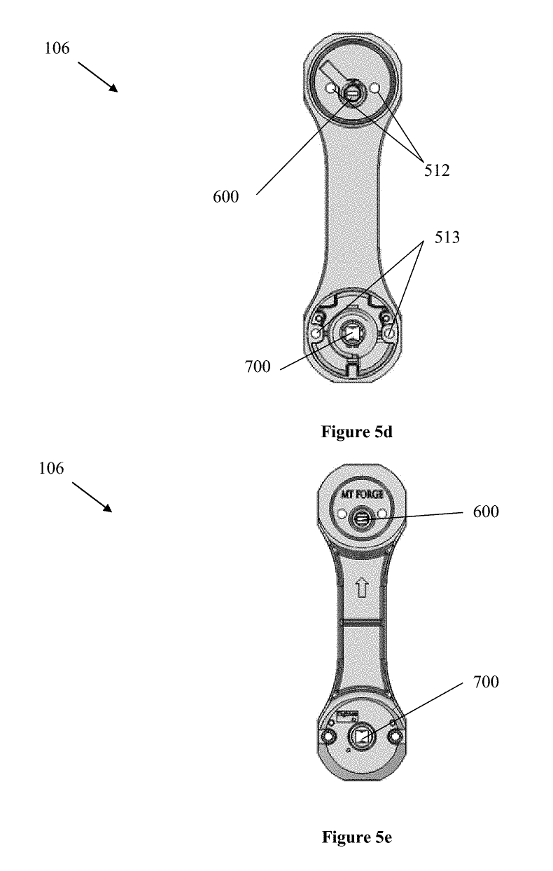

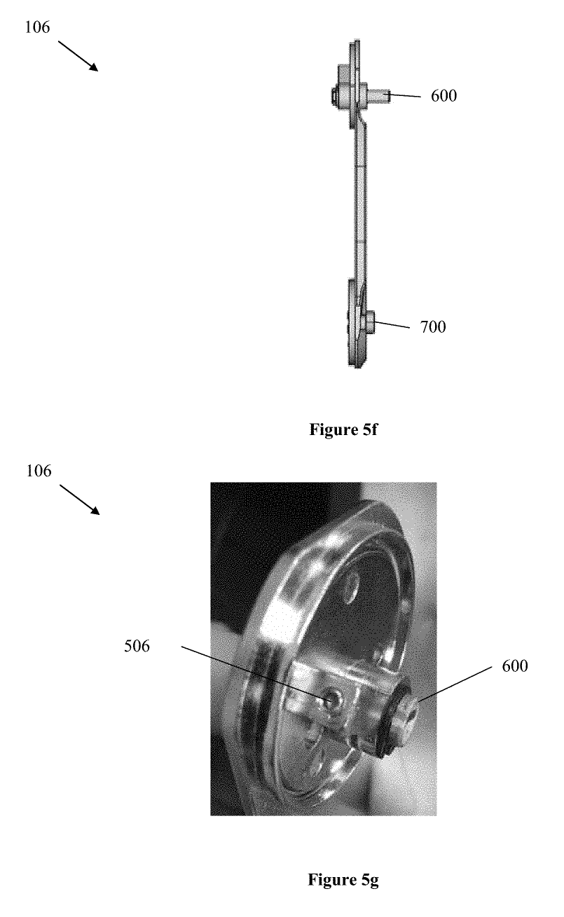

FIG. 5a shows an exploded rear perspective view of mounting plate 106. The upper end of mounting plate 106 comprises a rotatable stem 600 that is inserted into opening 501 and held in place with clip 502. Chimney housing 503 houses a catch 504, spring 505, and set screw 506. Ball 504 is sized and dimensioned to engage indentations in the surface of stem 600. Adjusting set screw 506 will increase or decrease the force of ball 504 against stem 600.

The lower end of mounting plate 106 comprises a rotatable spindle through-hole 700 that is inserted into opening 507 and held in place by clip 508. Clip 508 also hold torsion spring 509 and cover bracket 510 to the rear surface of mounting plate 106. The spring constant and torsional resistance of spring 509 can be selected (or replaced with a different spring) depending on the configuration for handle 115 (e.g., knob vs. lever). Spring 509 provides a resistance to the rotation of spindle through-hole 700. Spindle through-hole 700 has an opening that is sized and dimensioned to receive spindle 105. Spindle through-hole 700 has to opposing set screws 511 that engage two opposing grooves on spindle 105 (e.g., groove 901).

FIG. 5b shows a front perspective view of mounting plate 106. The upper end of mounting plate 106 has two assembly screw holes 512 on opposite sides of stem 600. The lower end of mounting plate 106 has two set screws 513 on opposite sides of spindle through-hole 700. Assembly screw holes 5512 and 513 are sized and dimensioned to receive assembly screws 107.

FIG. 5c shows a rear perspective view of mounting plate in 106.

FIG. 5d shows a rear plan view of mounting plate 106.

FIG. 5e shows a front plan view of mounting plate 106.

FIG. 5f shows a side view of mounting plate 106.

FIG. 5g shows a close-up top, rear, perspective view of mounting plate 106. Set screw 506 can be adjusted from this angle to increase or decrease the force on ball 504.

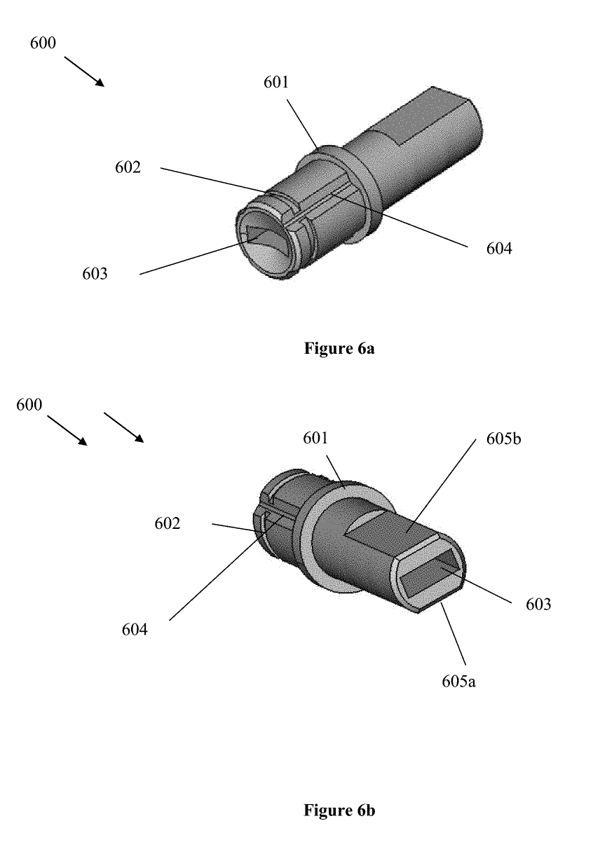

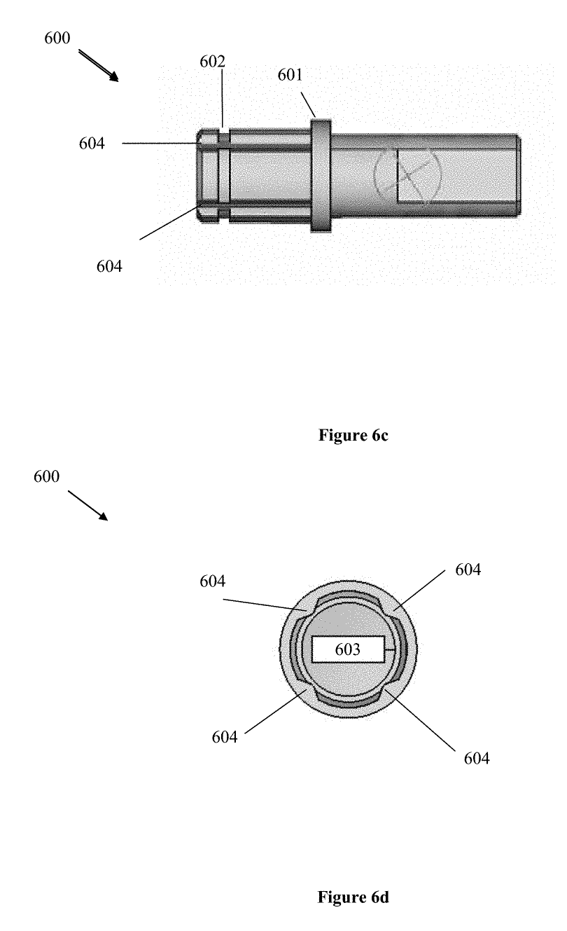

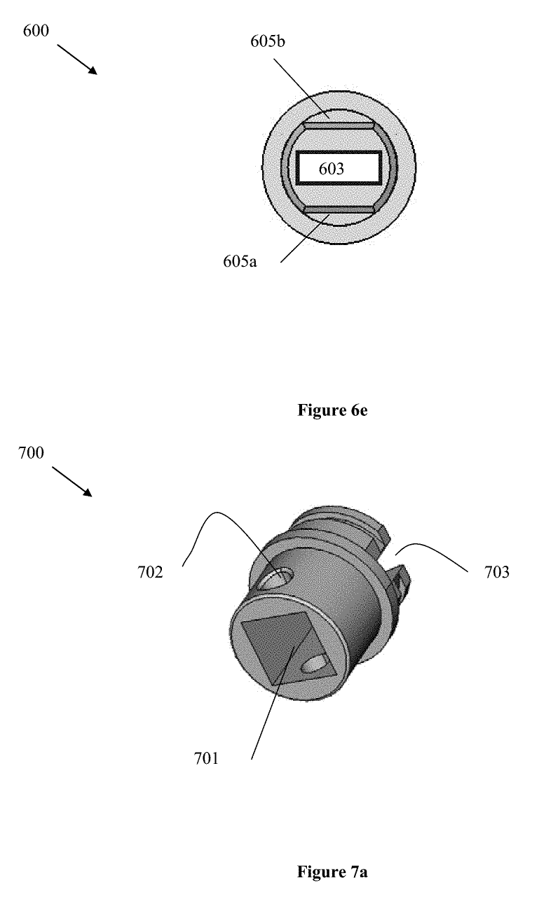

FIG. 6a shows a rear perspective view of stem 600. FIG. 6b shows a front perspective view of stem 600. FIG. 6c shows a side view of stem 600. Stem 600 is an elongated member with a longitudinal axis of rotation. Stem 600 has an annular flange 601 that is sized and dimensioned to stop stem 600 from completely passing through opening 501 in mounting plate 106. Stem 600 also has a radial groove 602 sized and dimensioned to receive ball 504. Ball 504 travels around groove 602 as stem 600 rotates. Stem 600 has an opening 603 through its center. Opening 603 has a cross section that is sized and dimensioned to receive, and mechanically engage with, tail piece 404 on deadbolt cylinder 102. When a user inserts a key in key hole 401 and rotates the key, tail piece 404 rotates, which rotates stem 600 and turn-piece 111.

FIG. 6d shows a rear plan view of stem 600. Stem 600 has four longitudinal grooves 604 that are spaced apart by a radial distance (e.g., 90 degrees). As stem 600 rotates 360 degrees, ball 504 travels around groove 602 and snaps into each of the plurality of longitudinal grooves 604 every 90 degrees. When ball 504 falls into grooves 604, stem 600 latches in place. Grooves 604 help turn-piece 111 and stem 600 to stay in their open position and closed position without wobbling or play or sagging over time.

FIG. 6e shows a front plan view of the stem 600. The front end of stem 600 has a cross sectional shape that mechanically engages opening 1000 in turn-piece 111 (see FIG. 10) so that stem 600 and turn-piece 111 rotate together. Turn-piece 111 also has a set screw 111a to rigidly fasten turn-piece 111 to stem 600.

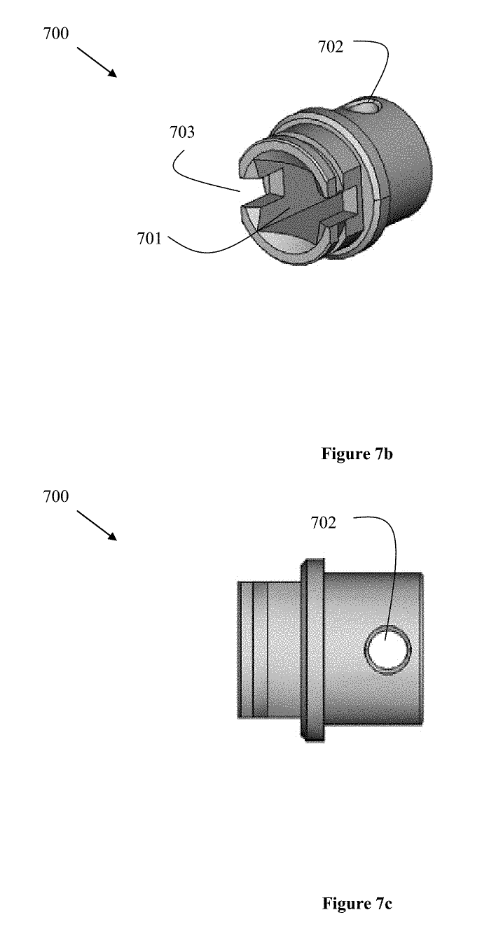

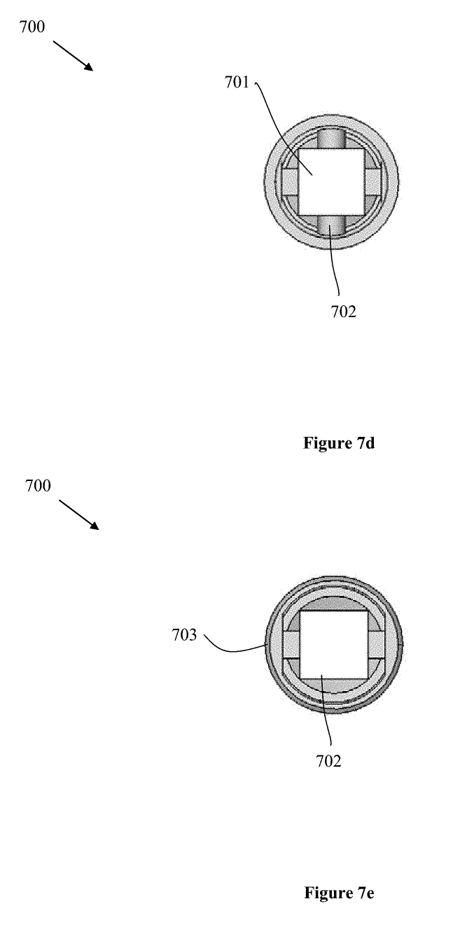

FIG. 7a shows a front perspective view of the spindle through-hole 700. Spindle through-hole 700 is sized and dimensioned to fit inside of, and removably couple with, opening 507. Spindle through-hole 700 is held in place by clip 508. Spindle through-hole 700 also has an opening 701 extending longitudinally from the front end to the back end. Opening 701 is sized and dimensioned to receive a spindle. Spindle through-hole 700 has a threaded opening 702 extending radially through the cylindrical body of spindle-hole 700. Opening 702 is sized and dimensioned to receive a set screw. Tightening a set screw in opening 702 when a spindle is disposed in opening 701 locks the spindle in place and helps to prevent lever sag and wobble.

FIG. 7b shows a rear perspective view of the spindle through-hole 700. The rear end of spindle through-hole 700 has a groove extending radially through the cylindrical body of spindle-hole 700. FIG. 7c shows a side view of the spindle through-hole 700. FIG. 7d shows a front plan view of the spindle through-hole 700. FIG. 7e shows a rear plan view of the spindle through-hole 700.

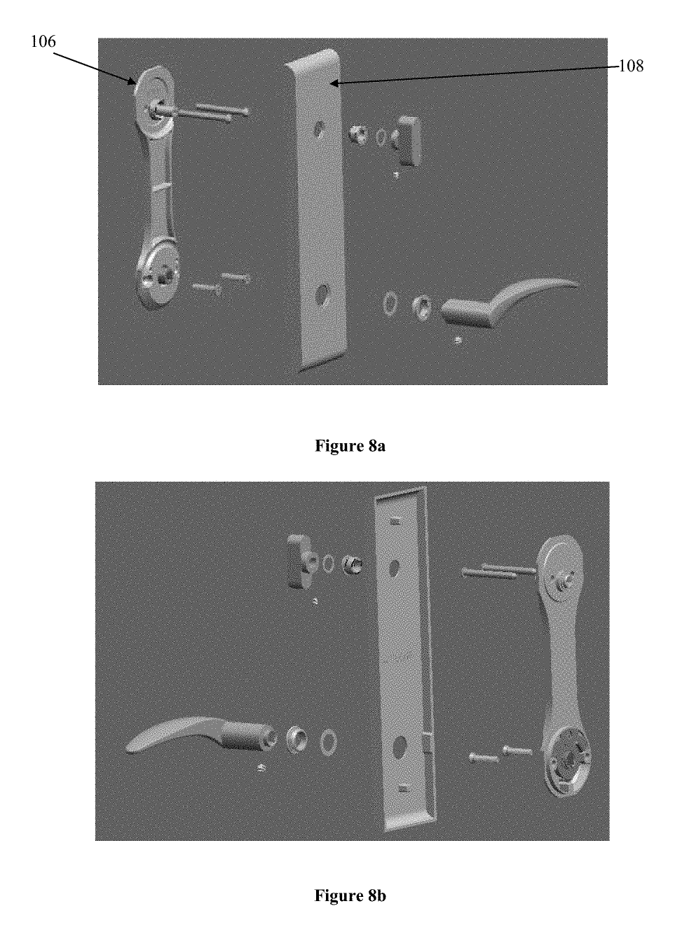

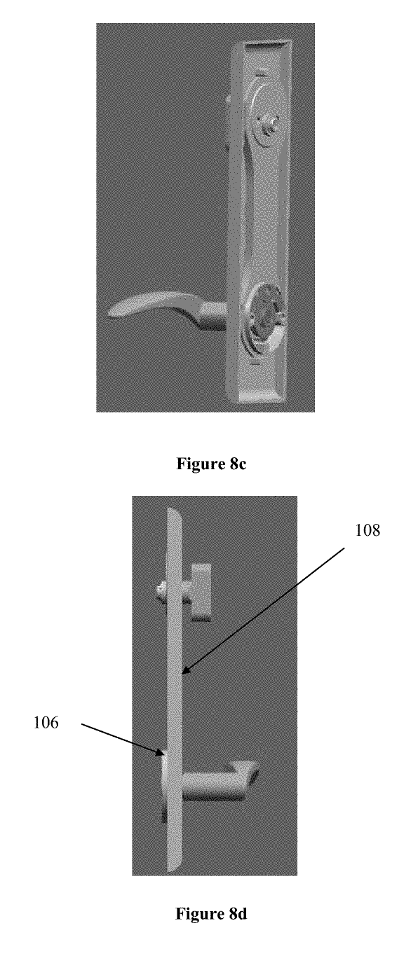

FIG. 8a shows an exploded front perspective view of the mounting plate 106 and faceplate 108. FIG. 8b is an exploded rear perspective view of the mounting plate 106 and faceplate 108. These exploded views show the order in which the components are assembled to construct mounting plate 106 and faceplate 108.

FIG. 8c shows a rear perspective view of the mounting plate 106 coupled with faceplate 108 in an assembled state. FIG. 8d shows a side view of the mounting plate 106 and faceplate 108.

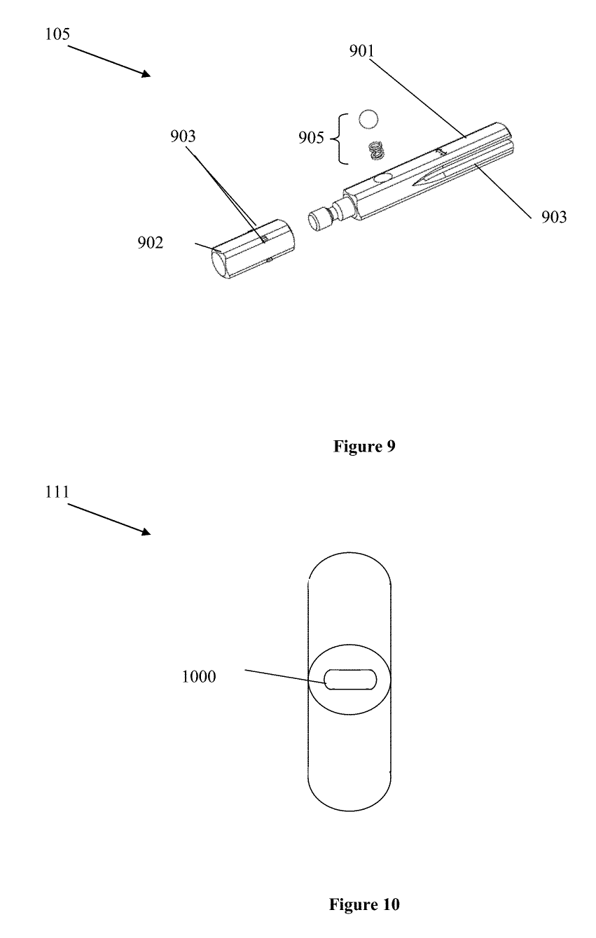

FIG. 9 shows an exploded view of the spindle 105. Spindle 105 has a first elongated member 901 rotatably coupled with a second elongated member 902. Elongated member 901 has two opposing longitudinal grooves 903 (the second groove is not visible from the perspective of FIG. 9). Grooves 903 are sized and dimensioned to engage with set screws on handle 115 and spindle through-hole 700. Spring-loaded ball catch 905 (e.g., detent) is spaced apart from protrusions 903 by a distance that is substantially equal to, or slightly larger than, the length of spindle through-hole 700. Ball catch 905 retracts in a flush position when spindle 105 is inserted into through-hole 700. Protrusions 903 are sized and dimensioned to prevent spindle 105 from being inserted further into through-hole 700. Protrusions 903 and ball catch 905 straddle through-hole 700 and keep spindle in place (e.g., on mounting plate 106) during assembly.

FIG. 10 shows a rear plan view of turn-piece 111. Turn-piece 111 has an opening 1000 that is sized and dimensioned to mechanically engage the end of stem 600.

From a methods perspective, the inventive subject matter includes a method of installing a concealed screw handleset. In one aspect, the concealed screw handleset comprises a faceplate having a first opening and a second opening spaced apart by a first distance; a mounting plate having a first threaded hole and a second threaded hole spaced apart by a second distance that is substantially equal to the first distance; a rotatable stem extending from the center of the first threaded hole and having a first longitudinal groove; a spindle through-hole sized disposed in the center of the second threaded hole and sized and dimensioned to receive a spindle; a first collar sized and dimensioned to fit in the first opening of the faceplate and having threads that mate with the first threaded hole; and a second collar sized and dimensioned to fit in the second opening of the faceplate and having threads that mate with the first threaded hole.

The method comprises the steps of: (i) installing the mounting plate onto a first major surface of a door such that the rotatable stem and spindle through-hole are aligned with a first through-hole and a second through-hole, respectively, on the door; (ii) fastening the faceplate to the mounting plate and to the first major surface of the door by (a) aligning the first opening and second opening of the faceplate with the first threaded hole and second threaded hole, respectively, of the mounting plate; (b) inserting the first collar through the first opening of the faceplate from an outward facing surface of the faceplate, and threading the first collar to the first threaded hole of the mounting plate; and (c) inserting the second collar through the second opening of the faceplate from the outward facing surface of the faceplate, and threading the second collar to the second threaded hole of the mounting plate.

In some embodiments, the step of installing the mounting plate onto a first major surface of a door comprises: (i) inserting a tailpiece of a deadbolt cylinder into a key hole in the center of the rotatable stem of the mounting plate from a second major surface of the door; (ii) fastening the deadbolt cylinder to the mounting plate with one or more assembly screws; (iii) inserting the spindle into the spindle through-hole; (iv) placing a chassis member of a handleset onto an end of the spindle from the second major surface of the door; and (v) fastening the chassis member to the mounting plate with one or more assembly screws.

In another aspect of some embodiments, the method further comprises the steps of: (i) attaching a turn-piece to the stem from the outside surface of the faceplate, wherein the turn-piece is sized and dimensioned to completely cover the first collar; and (ii) attaching a handle to an end of the spindle from the first major surface of the door, wherein the handle is sized and dimensioned to completely cover the second collar.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Also, as used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

Thus, specific compositions and methods of concealed screw handleset assembly have been disclosed. It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure all terms should be interpreted in the broadest possible manner consistent with the context. In particular the terms “comprises” and “comprising” should be interpreted as referring to the elements, components, or steps in a non-exclusive manner, indicating that the referenced elements, components, or steps can be present, or utilized, or combined with other elements, components, or steps that are not expressly referenced.

What is claimed is:

1. A concealed screw handleset assembly comprising:
a faceplate having a first opening and a second opening separated by a first distance;
a mounting plate having a first threaded hole and a second threaded hole separated by a second distance substantially equal to the first distance, such that the first threaded hole and second threaded hole align with the first opening and second opening, respectively, when the mounting plate is coupled with the faceplate;
a first collar sized and dimensioned to fit in the first opening of the faceplate and having threads that mate with the first threaded hole;
a second collar sized and dimensioned to fit in the second opening of the faceplate and having threads that mate with the first threaded hole.

2. The handleset assembly of claim 1, wherein the first collar and the second collar each have an annular flange sized and dimensioned larger than the first opening and second opening, respectively.

3. The handleset assembly of claim 2, wherein the first opening and second opening have an annular recess for receiving the annular flange of the first collar and second collar, respectively, such that the first collar and second collar are flush within an outside surface of the faceplate.

4. The handleset assembly of claim 3, wherein the annular flange of the first collar and second collar each have a plurality of grooves.

5. The handleset assembly of claim 4, further comprising a tool having a first plurality of teeth on a first end sized and dimensioned to engage the plurality of grooves of the first collar and a second plurality of teeth on a second end sized and dimensioned to engage the plurality of grooves on the second collar.

6. The handleset assembly of claim 1, wherein the mounting plate further comprises a rotatable stem extending from the center of the first threaded hole and having a key hole.

7. The handleset assembly of claim 6, wherein the mounting plate further comprises a rotatable spindle through-hole disposed in the center of the second threaded hole.

8. The handleset assembly of claim 7, further comprising a spindle sized and dimensioned to fit in the spindle through-hole of the mounting plate.

9. The handleset assembly of claim 7, wherein the mounting plate further comprises a first threaded set screw hole disposed on a first side of the spindle through-hole.

10. The handleset assembly of claim 9, wherein the mounting plate further comprises a second threaded set screw hole disposed on a second side of the spindle through-hole, wherein the second side is opposite to the first side.

11. The handleset assembly of claim 8, further comprising a handle having an opening for receiving the spindle.

12. The handleset assembly of claim 11, wherein the handle is sized and dimensioned to completely cover the second collar when coupled with the second collar, faceplate, spindle, and mounting plate.

13. The handleset assembly of claim 8, further comprising a turn-piece that has an opening sized and dimensioned to receive the stem of the mounting plate.

14. The handleset assembly of claim 13, wherein the turn-piece is sized and dimensioned to completely cover the first collar when coupled with the first collar, faceplate, and stem of the mounting plate.

15. The handleset assembly of claim 9, wherein the spindle through-hole of the mounting plate has a first threaded set screw sized and dimensioned to mate with the first threaded set screw hole and engage a groove of the spindle.

16. The handleset assembly of claim 11, wherein the handle has a first set screw sized and dimensioned to engage a groove on the spindle.

17. The handleset assembly of claim 12, wherein the handle comprises a knob or lever.

18. A handleset assembly comprising:
a faceplate having a first opening and a second opening;
a mounting plate having a first threaded hole and a second threaded hole that aligns with the first opening and second opening when the mounting plate is coupled with an inside surface of the faceplate;
a rotatable stem extending from the center of the first threaded hole;
a first longitudinal groove and a second longitudinal groove disposed on a side of the stem and separated by a radial distance;
a catch mechanism comprising a spring coupled with a catch, wherein the catch is biased to move towards the stem and engage the first longitudinal groove and second longitudinal groove when the stem is rotated.

19. The handleset of claim 18, wherein the catch mechanism further comprising a set screw coupled with the spring such that tightening the set screw increases the bias of the catch towards the stem.

20. A handleset assembly comprising:
a faceplate having a first opening and a second opening;
a mounting plate having a first threaded hole and a second threaded hole that aligns with the first opening and second opening when the mounting plate is coupled with an inside surface of the faceplate;
a rotatable stem extending from the center of the first threaded hole and having a first cavity; and
a lock mechanism comprising a pin coupled with a set screw, wherein the pin is positioned to engage the cavity of the stem such that the stem is prevented from rotating.
